(19) United States
(12) Patent Application Publication
(10) Pub. No.: US 2006/0004586 A1
(43) Pub. Date: Jan. 5, 2006

(54) Automated purchasing method with features for high volume purchasing

(75) Inventors: Stephen Graf, Neenah, WI (US); Robert F. Hanley JR., Neenah, WI (US); Todd T. Lankey, Appleton, WI (US); Jeffrey R. Ellis, Neenah, WI (US); Carol E. Holcombe, Neenah, WI (US)

Correspondence Address: DORITY & MANNING, P.A., POST OFFICE BOX 1449, GREENVILLE, SC, 29602-1449, US

(73) Assignee: KIMBERLY-CLARK WORLDWIDE, INC.

(21) Appl. No.: 10/881,698

(22) Filed: Jun. 30, 2004

(51) Int. Cl. G06F 17/60

(52) U.S. Cl. 705/1

(57) ABSTRACT

An automated purchasing method for buyers using a high volume database and a high volume software program that is compatible with SAP® business management software having an SAP material master database includes creating a new record upon having received a request for purchase of a new item, determining whether the new item is a high volume item, determining whether the new item has a matching entry in a high volume database, and either automatically or manually updating a purchasing info record and source list entry for the item. A requisition and purchase order for the new item may then be sent to a vendor. Optimized prices may be negotiated from the vendor based on documented records of the total items purchased from various respective manufacturers and vendors. Updates or discounts then applicable to the given purchase order are returned and updated in the high volume system such that those discounts and pricing updates are available for subsequent requests and purchases via the high volume program.

### BACKGROUND OF THE INVENTION

Many businesses use a universal business management software that provides applications for managing and handling a variety of business aspects, including purchasing. This software has been developed by a German-based company named Systeme, Andwendungen, Produkte in der Datenverabeitung, (Systems, Applications, Products in Data Processing) and is generally referred to as SAP® products (hereafter “SAP”).

Businesses typically require the purchase of numerous items each day. For example, a large company may purchase 1000 items or more in various quantities on an average day. Keeping abreast of so many purchases might require a purchasing staff of over 100 people. Of the 1000 items purchased on average on a typical day, anywhere from two-thirds to 80% might fall into the category of purchases in support of maintenance activities, repair activities, or operating activities of the business. Such items that are used for plant maintenance, repair and operations typically are low value items that are purchased in high volumes on a repeated basis. Moreover, of these 1000 items purchased each day on average, about 20% may be completely new items that never have been purchased before.

The many users of SAP have a need for improved purchasing systems that are compatible with SAP, particularly for high volume purchasing related to consumable supplies used, for example, for plant maintenance, repair, and operations. Under existing SAP systems, when new items from a known vendor are entered into the user's purchasing system, a heavy burden is placed on the user's purchasing agents in that they must create new item numbers, negotiate pricing with the vendors, and so forth. In general, setting up the user's purchasing system to process the new item requires substantial time. Dealing with the new items, including their introduction into the SAP system, may occupy between 25% and 30% of the human resources of the purchasing department.

Before businesses used SAP, high volume purchasing was facilitated through the use of a previous known purchasing application that employs a commodity code that contains information about what the item is and how the item is to be used. The new item is also typically linked to a manufacturer's name. This linkage can be achieved by using a table of manufacturers developed by the user of the purchasing system. Once the commodity code is established and the manufacturer has been identified, then the previous known purchasing application can automatically send a purchase order to a specific vendor for the given commodity code, manufacturer, and shipping location.

Unfortunately, there have not been any equivalent options similar to those of the above-referenced known purchasing application under SAP. Existing purchasing systems that are recommended by SAP for handling the procurement of maintenance, repair and operating supplies provide no means for capturing the purchase history of selected items. Nor do the existing purchasing systems recommended by SAP provide any means for capturing the manufacturers of the selected items. This leads to inefficiencies and lost discount opportunities for high volume purchasing. Some users of SAP have dealt with these deficiencies in SAP by creating separate systems to manage purchasing for high volume items related to maintenance, repair, and operating supplies.

As such, a need exists for an automated purchasing system that is compatible with SAP® business management software applications and that effectively addresses needs associated with high volume purchasing of consumable supplies.

### OBJECTS AND SUMMARY OF THE INVENTION

Objects and advantages of the invention will be set forth in part in the following description, or may be obvious from the description, or may be learned through practice of the invention.

It is an advantage of some embodiments of the present invention that automated purchasing systems are provided which are compatible with SAP® business management software or that are operative in an environment running SAP® software programs.

A further advantage of some embodiments of the present invention concerns the provision of an improved system for purchasing items that are consumed in high volumes, such as items related to maintenance, repair and operating supplies.

In one exemplary embodiment of the present technology, a purchasing method allows SAP to automatically create new item numbers (which SAP refers to as material masters) employing commodity code concepts (e.g., information about how the item will be used is included in the commodity code), and then to set up and create a purchase order without the need for effort from a buyer. In accordance with such a purchasing method, a system user captures the history of purchase orders and uses this history to compile respective records of the total purchases of products from individual manufacturers as well as the total purchases from particular vendors. The compiled information may then be used to negotiate for each manufacturer and vendor a standard discount applicable to new items of the manufacturer to be purchased from the vendor. An item master database containing each standard discount applicable to manufacturers and vendors may be utilized to order never-before-purchased items, for example, from one of the manufacturers through one of the vendors. Information records may be automatically created and include such information as the commodity code, manufacturer's name, and delivery point information for a new item. The information record may subsequently be used to generate a purchase order for the item which is then transmitted to either the manufacturer or the vendor.

Another exemplary embodiment of the present subject matter concerns an automated purchasing method for buyers using a high volume database and a high volume software program that is compatible with SAP® business management software (referred to hereafter as an SAP program) having a SAP material master database. In accordance with such a method, the high volume program receives a request for the creation of a new record for a new item for future purchase. The request contains a plurality of data entries (e.g., any combination of a description of the item, a commodity code associated with the item, an identifier of the manufacturer of the item, a manufacturer's product code for the item, an estimated price of the item based on, for example, user's research in relevant vendor catalogs, and a place where the item is to be shipped). The high volume program then provides the request to the SAP program, which creates a new record and provides the new record back to the high volume program. The high volume program then examines the new record to determine that the corresponding item is a high volume item, such as one related to maintenance, repair, operating supplies, etc. The high volume program then consults a high volume database, which contains different types of items each respectively characterized by sourcing data (e.g., a purchasing info record or an outline agreement) and a source list entry. A determination is made as to whether any of the items in the high volume database matches the new record. Such a determination may be made in some embodiments of the subject methodology by comparing identifiers for the new item, the manufacturer of the new item and the facility requesting the new item to existing records in the database.

Referring still to the above exemplary purchasing method, the high volume program may determine either that the new item does not match one of the items in the high volume database, or that it does match one of the items in which case such item(s) are selected by the high volume program. If a matching item is found, the high volume program automatically creates new sourcing data (e.g., a purchasing info record or outline agreement) based on an estimated price from the item request and the sourcing data from the matching item and adds this purchasing info record to the SAP material master database. A source list entry is also automatically created for the new item using the data entries from the item request, and this source entry is also stored in the SAP material master database. If a matching item is not found in the database, the buyer is notified that the SAP program has created a new “material”. The buyer then manually creates a purchasing info record and source list entry for entry to the SAP material master database.

In accordance with other exemplary embodiments, additional steps to the aforementioned process include submitting a requisition for purchase of one or more of the new items. The high volume program then automatically creates a purchase order for the new items based on the record stored in the SAP material master database. The purchase order may then be provided to a vendor. If the vendor has purchasing updates for the order, those updates will be provided by way of, for example, an electronic data interface (EDI) acknowledgement, a phone communication, or a facsimile communication. The buyer then manually updates the purchase order, the purchasing info record and the source list entry such that the pricing updates received from the vendor are available for subsequent requests and purchases.

Still further aspects of the present subject matter concern a user interface for an automated purchasing system. The user interface may include a plurality of templates that are embodied in a graphical Web-based interface. A first exemplary template may be configured with data fields for entering information to request a new item, such as information including one or more of a description of the new item, a commodity code associated with the new item, the identity of the manufacturer, manufacturer's product code for this item, the estimated price of the item, and the location where the item is to be shipped. A second exemplary template is configured for entering a purchasing info record for the new item, and may include data fields associated with pricing, administration information and text information governing a vendor/purchaser relationship for said new item. More specific examples of data fields for such as second exemplary template include one or more of a base price, applicable surcharges and discounts, freight, taxes, vendor part number, business contact for the new item, and vendor commodity code for the new item. A third template may be employed for formulating a source list entry for said new item, wherein the source list entry includes information for all sourcing data across all vendors for the new item for a particular location.

Still further aspects of the present subject matter concern a computer-readable medium embodying one or more programs of instruction executable by a computer for performing method steps as selectively described in the aforementioned exemplary embodiments.

Other features and aspects of the present invention are discussed in greater detail below.

### BRIEF DESCRIPTION OF THE FIGURES

FIGS. 1 and 2 combine to provide a schematic representation of one embodiment of a high volume, automatic purchasing system compatible with SAP in accordance with exemplary aspects of the present invention.

### DETAILED DESCRIPTION OF THE INVENTION

Reference now will be made in detail to the presently preferred embodiments of the invention. Each example is provided by way of explanation of the invention, not limitation of the invention. In fact, it will be apparent to those skilled in the art that various modifications and variations can be made in the present invention without departing from the scope or spirit of the invention. For instance, features described as part of one embodiment of the invention, can be used on another embodiment to yield a still further embodiment. Thus, it is intended that the present invention covers such modifications and variations as come within the scope of the appended claims and their equivalents.

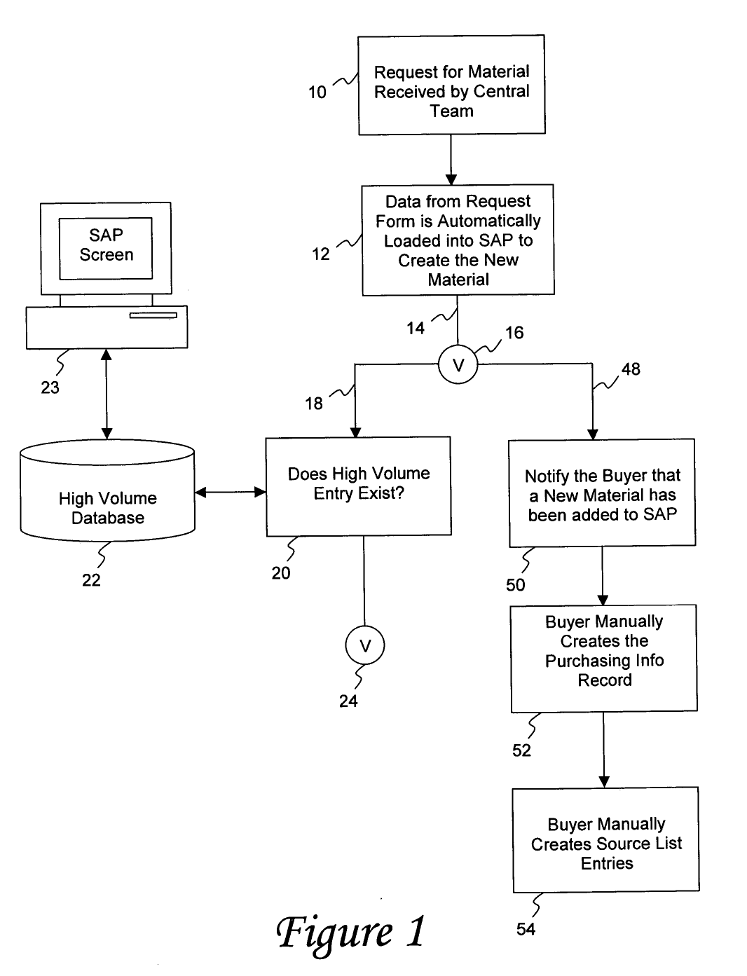

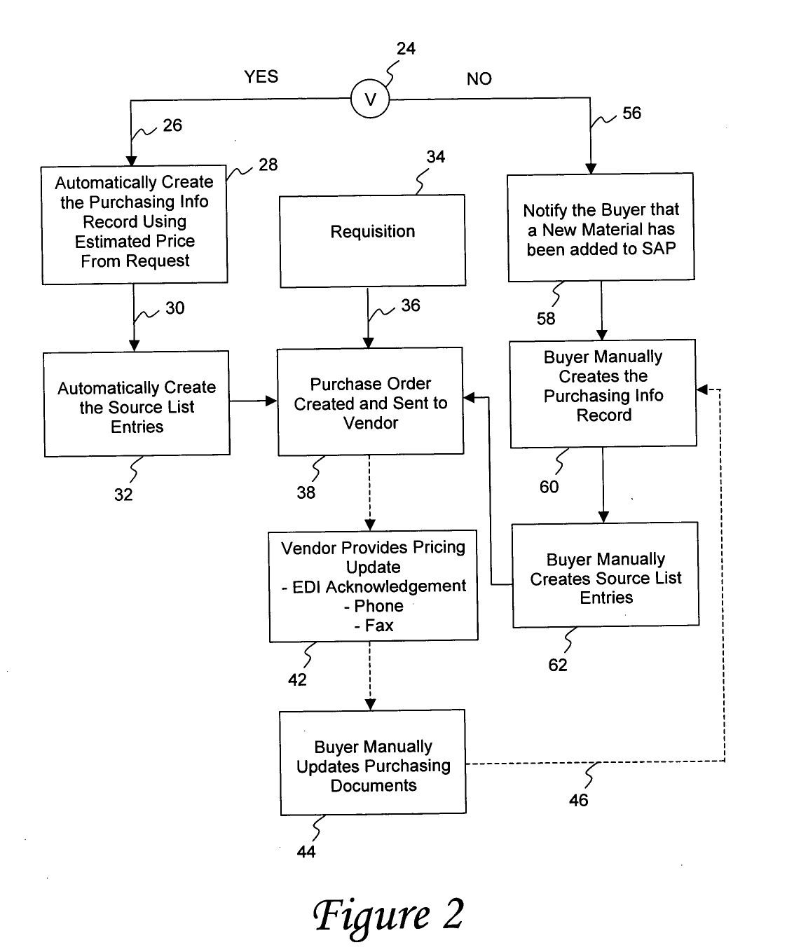

An illustrative embodiment of the subject invention is schematically shown in FIGS. 1 and 2. Referring to the figures, assume for purposes of this example that a business purchases a new machine for one of its manufacturing plants, and the machine is installed in the plant. This machine requires daily replacement of a component that wears during operation of the machine, and for the sake of this illustration, this component will be designated by the name “widget.” Mindful that this plant will need to carry an inventory of widgets to support operation of this new machine, the engineer in charge of operating this machine sits down at a computer terminal and logs on to the business' management information network. There, a template for requesting new materials is called up. This template requires the engineer to supply certain information about the widget. For example, included in the information to be supplied, may be any combination of: a description of the item (in this case the widget), a commodity code associated with this item, the identity of the manufacturer, the manufacturer's product code for this item, the estimated price of the item, and the location where the item is to be shipped. The information is entered into the template that is provided for this request for material, and the request for material is transmitted into the management information network of the business.

The management information network forwards (e.g., in the form of an electronic mail (e-mail)) this request for material to an employee(s) of the business, who reviews the request for material and checks the entries in the standard electronic form that forms the request for material. This is represented as step 10 in the schematic diagram of FIG. 1. This review determines whether the information conforms to the information that can be converted by the SAP software to be listed on the SAP's material master. Essentially, this step performs a quality control function over the information that is carried by the request for material, and any information that does not conform is corrected. Once the request for material is in proper form, it is transmitted electronically to the SAP software, which creates a new record for this item and adds this record to the SAP material master database. The creation of this record is schematically illustrated in FIG. 1 by the block designated 12.

As schematically indicated by the line designated 14 in FIG. 1, the SAP program provides the new record for the widget to a high volume program. As schematically indicated by the circle designated 16, the high volume program inspects the new record for the widget and determines from the information in this new record, whether the widget is the type of item that would be considered a high volume item. A high volume item is an item that a business typically would purchase in large quantities at relatively low values on a repeated basis. Examples of such items would be items used for maintenance, repair and operations of the business. Having determined that the widget is such a high volume item, the high volume software treats the widget as a high volume item and prepares to perform the next operation on the new record. This is schematically indicated by the arrowed line designated 18 in FIG. 1.

As schematically indicated by the block designated 20 in FIG. 1, the high volume program consults a high volume database 22. This high volume database 22 contains different types of items and in some embodiments corresponds to a database that is accessible via a computerized network such as a local area network (LAN) at one or more given corporate facilities, an intranet established among multiple users or facilities within an entire corporation, or a globalized computer network such as the Internet. Although represented as a single structure in FIG. 1, it should be appreciated that high volume database 22 may in some embodiments comprise multiple databases linked together across a computerized network.

In one embodiment, the high volume computer program and related software includes one or more instructions for execution by a computer. The program may be stored in a memory or other computer-readable medium such as a carrier wave, a magnetic disk or tape, a CD-ROM, a flash memory or other nonvolatile memory, memory resident on a computer, etc. These and other memory locations may be associated with the same server or computer network that implements the SAP program or may be stored and implemented from a separate server.

SAP Screen represented schematically by computer module 23 in FIG. 1 represents the user interface with which a buyer/associate can access the high volume database 22 and maintain and update the database in a manual fashion when needed. Database maintenance includes such functions as additions, modifications and deletions in high volume database 22. For each type of item in the high volume database, there is a purchasing info record and a source list entry, each one compatible with the SAP software. Additional information that may be available for each item in the high volume database includes the history of purchase orders, including total purchases of products from individual manufacturers or from respective vendors.

In one embodiment, the SAP screen 23 may be utilized to access aspects of the subject high volume program. In other embodiments, a separate interface for the high volume program may be provided, whereby the separate high volume interface is customized to effectively interact with SAP and related aspects thereof. The SAP screen interface and/or the high volume program interface when provided as a separate feature may be provided in an Internet-enabled environment or via a comprehensive Web-based interface.

Integration of the high volume program, including high volume database 22 and any interfaces to the high volume program may be particularly configured to interface with SAP brand software, particularly SAP/R3 systems. Interfacing of custom software with SAP/R3 systems is described by B. Yeager in “Mead's ERP System Integrates ‘Best of Breed’ Software,” PIMA's North American Papermaker, vol. 82, no. 4, April 2000, p. 36. For example, encapsulation of custom software, such as any PIPE or STORM component, may occur within SAP brand software using SAP brand software interface programs, called “BAPIs” (business application programming interfaces), which use Microsoft Corp.'s COM/DCOM connectors, allowing a Microsoft-based client to communicate with SAP R/3. Such connectors may be built using ACTIVEX brand technologies by Microsoft Corp. and COM/DCOM strategies. Other aspects of applying a SAP brand software system for use with the present invention are disclosed by O. Wieser in “Integration of Process Control Systems and Laboratory Information Systems Into the Logistic Chain,” Automatisierungstechnische Praxis, vol. 39, no. 2, February 1997, pp. 26-28.

A purchasing info record (PIR) for a given item type is a singular record that controls the vendor-material relationship. For an item that is being purchased from a given vendor or supplier, information provided in the PIR typically dictates the pricing, administration information and text information. Exemplary pricing variables include a based price, applicable surcharges and discounts, freight, taxes, etc.) Exemplary administrative information may include one or more of the vendor's part number for the manufacturer's material master data, a business contact for the manufacturer's material, a vendor commodity code, etc.). Text information may correspond to purchase order relevant text, internal text pertinent to the manufacturer, or other text classifications).

It should be appreciated that although PIRs typically provide vendor-material information for a single item that may be requested for purchase, other options may be employed in accordance with the presently disclosed technology for recording a relationship between a given vendor and multiple materials. Such multi-material vendor relationship information may be accessed via a group of data records referred to in SAP® applications as “outline agreements”. Outline agreements include contracts and scheduling agreements between a vendor and manufacturer for one or more designated items and record such information as item pricing, terms and conditions of purchase. The total collection of PIRs and outline agreements may be generally referred to herein as sourcing data.

It should be appreciated based on the above characterizations that a PIR provides information on a particular material and vendor, while an outline agreement provides information on a vendor and multiple selected materials. An extension to the type of information found in PIRs and outline agreements can be determined from a source list. A source list combines all PIRs and outline agreements across all vendors for a given material in a particular plant, thus gathering all sourcing data for a given item into a single collection of information. Source lists may also have features that allow a buyer to block certain source of supply records and to choose one as the primary source.

As schematically indicated by the block designated 20 in FIG. 1, the high volume software determines which of the items in the high volume database 22 matches the new record for the widget and selects any matching items from the high volume database. A matching item will have associated with it a purchasing info record and a source list entry. Matching items may be determined by looking for equivalence in a predetermined group of data variables such as but not limited to the material group, manufacturer identifier (e.g., name or number) and plant identifier (e.g., name or number), when comparing the new item to existing items in the high volume database. The decision process associated with determining if any matching items exist is schematically indicated in FIG. 1 by the circle designated 24. The node for decision process 24 is also depicted in FIG. 2 from which subsequent steps in the present methodology follow based on a “yes” or “no” determination, respectively represented by lines 26 and 56.

Referring now to FIG. 2, the affirmative selection of a matching item in the high volume database 22 by decision process 24 is schematically indicated by the arrowed line designated 26. As schematically indicated by the block labeled 28 in FIG. 2, the high volume software uses the estimated price from the request and the purchasing info record, including but not limited to the commodity code (material group), manufacturer's name, delivery point (e.g., plant) information, purchasing group number and vendor number, from the matching item and creates a purchasing info record for the widget as well as adding this purchasing info record to the SAP program material master database. The next step is indicated by the arrowed line designated 30. Line 30 leads to the block designated 32 in FIG. 2. As schematically indicated by the block designated 32, the high volume software uses the data from the request and the source list entry for the matching item to automatically create a source list entry for the widget. The step schematically designated 32 could be performed before the step designated 28 in FIG. 2, if desired. The source list entry for the widget then is added to the SAP program material master database by the high volume software.

When it comes time to buy more widgets, a requisition is made for widgets. This is schematically represented in FIG. 2 by the block designated 34. The requisition is supplied to the purchasing department as indicated by the arrowed line designated 36 in FIG. 2. The high volume software automatically creates in a step represented by block 38 a purchase order from the record that is stored in the SAP master materials database. In further accordance with step 38, the high volume software then electronically sends the purchase order to the vendor. In some instances, the vendor may have pricing updates upon receipt of the purchase order. If pricing updates are available, the vendor notifies the buyer in a step represented by block 42. Notification may be provided in such exemplary forms as an EDI acknowledgement or an electronic form such as by telephone, facsimile transmission, e-mail, etc. The buyer receives this updated information from the vendor, at which point any updates to the purchasing documents may be revised manually by the buyer in a step represented in FIG. 2 by block 44.

Because this is a high volume item, the purchasing department of the business may have previously negotiated a set discount from the list price of the vendor. Thus, even though the widget never had been purchased before, there already would be an established discount rate from the retail price based on prior negotiations with the vendor by the purchasing department of the business. Having this discount in place eliminates the need for the purchasing department of the business to separately negotiate the price for this widget with the vendor. Moreover, by combining the purchasing information from multiple vendors for products from a particular manufacturer, the purchasing department of the business can obtain a better discount on the basis of the volume of purchasing that is done by this business than would have been possible if the business dealt with a single vendor for just one of the plants of the business. The existence of the high volume database makes all of this possible as a practical matter. For the high volume database is essentially the result of capturing the history of purchase orders in order to identify the total purchases of products from individual manufacturers. The total purchases from a particular vendor can be added to the high volume database.

After the buyer manually updates the purchasing document in step 44, the subject process proceeds as indicated along dotted line 46 to step 60 where the buyer updates the purchasing info record that will be used for all subsequent orders. A source list entry is also manually updated by the buyer in step 62. The updated purchase order and the updated source list entry are both added to the high volume database. The dotted lines in the flow chart of FIG. 2 are intended to represent an optional procession of steps that are triggered only if the buyer is notified by the vendor of a pricing update. Otherwise, the subject purchasing process is completed upon creation and relaying of the purchase order in step 38. When pricing updates are available, and the purchasing documents, purchasing info record and source list entry are all updated in respective steps 44, 60 and 62, the process returns to step 38. Upon returning to step 38 after pricing updates, the high volume software program automatically creates an updated purchase order and issues the updated purchase order to the vendor. The vendor may then send acknowledgement of receipt of the updated purchase order. Such acknowledgement may be known by both the high volume software program and the buyer.

Reference is now again directed to FIG. 1. As schematically indicated by the arrowed line designated 48 in FIG. 1, if the high volume software determines in decision process 16 that the widget is a type of item other than a high volume item, then the new record created by the SAP software is forwarded to the buyer in a step represented by block 50. In this case, as schematically indicated by the block designated 52 in FIG. 1, the buyer must manually create the purchase info record for the new item. Similarly, the buyer must manually create the source list entry for the new item. The creation of the source list entry is schematically represented in FIG. 1 by the block designated 54.

Referring to FIG. 2 and the arrowed line designated 56, this represents the situation when the widget has been determined in step 16 to be a high volume item, but a determination has been subsequently made in step 24 that no entry exists for that item in high volume database 22. In such as case, as schematically indicated by the block designated 58, the high volume software notifies the buyer that a new material (the widget) has been added to the master material database of the SAP. As schematically indicated by the block designated 60 in FIG. 2, the buyer then must manually create the purchasing info record for the new material (the widget) and enter the purchasing info record into the master material database of the SAP. As schematically indicated by the block designated 62 in FIG. 2, the buyer also must manually create the source list entry for the new material (the widget) and enter the source list entry into the master material database of the SAP.

It will be appreciated that the steps designated 50, 52, and 54, pertain to situations when the new material (the widget) is something other than a high volume item. Similarly, the steps designated 58, 60, and 62, represent a situation in which the new material (the widget) is a high volume item, but has not yet been entered into the high volume database. In both of these situations, manual operations must be performed by the personnel of the purchasing department. However, it is estimated that these types of situations only constitute about 25% or less of the total queries that are handled by the high volume software in cooperation with the SAP software. Accordingly, the high volume software will routinely operate automatically and independently of the manual operations performed by the personnel of the purchasing department for 75% or more of the situations that the business will present to the purchasing department each day. This represents a substantial savings in terms of the resources devoted by the purchasing department to the purchase of high volume on behalf of the business. As a consequence of the present invention, those numerous business organizations that run SAP software systems will be able to take advantage of this substantial gain in productivity by the purchasing department of the business.

The type of item will identify what the item is and how the item is to be used. There are a number of different types of items. The item may be classified as a maintenance type because it is to be used to maintain plant and equipment. The item may be classified as a raw material type because it is to be processed into a different item during a manufacturing process for example. The item may be classified as an operating supply type because it is to be used or consumed during operation of a manufacturing process for example.

While the specification has been described in detail with respect to specific embodiments of the invention, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

What is claimed:

1. An improved purchasing method for buyers using a high volume database and a high volume software program that is compatible with SAP® business management software (hereafter SAP program) having a SAP material master database, said method comprising the steps of:
(a) the high volume program receiving a request for the creation of a new record for a new item for future purchase, said request containing a plurality of data entries including an estimated price that are provided to the SAP program by the high volume program;
(b) from said data, the SAP program creating the new record and providing same to said high volume program;
(c) the high volume program examining the new record and determining that the item is a high volume item;
(d) the high volume program consulting the high volume database, which contains different types of items each respectively characterized by given sourcing data and a source list entry, and determining whether any of the items in said high volume database matches the new record;
(e) the high volume program determining that the new item matches one of the items in the high volume database and selecting the matching item;
(f) using the estimated price from the request and the given sourcing data for said matching item, the high volume program automatically creating new sourcing data for said new item and adding said new sourcing data to the SAP material master database; and
(g) using selected of the plurality of data entries from the request and the source list entry for said matching item, the high volume program automatically creating a source list entry for said new item and adding said source list entry to said SAP material master database.

2. The method of claim 1, wherein said plurality of data entries from said request further comprise one or more of a description of the item, a commodity code associated with the item, an identifier of the manufacturer of the item, a manufacturer's product code for the item, an estimated price of the item, and a place where the item is to be shipped.

3. The method of claim 1, wherein said step of the high volume program consulting the high volume database and determining whether any of the items in said database matches the new record comprises comparing identifiers for one or more of the new item, the manufacturer of the new item, and the facility requesting purchase of the new item.

4. The method of claim 1, wherein said given sourcing data and said new sourcing data respectively comprise a purchasing info record configured to provide details about a vendor/purchaser relationship for said new item.

5. The method of claim 1, wherein said given sourcing data and said new sourcing data respectively comprise an outline agreement configured to provide details about a vendor/purchaser relationship for multiple items including said new item.

6. The method of claim 1, wherein said given sourcing data and said new sourcing data comprise information respectively characterized by at least one of pricing, administrative information, and text information.

7. The method of claim 1, further comprising the steps of:
(h) submitting a requisition for purchase of one or more of said new items; and
(i) the high volume program automatically creating a purchase order for the requested new items, said purchase order created from the record stored in said SAP material master database.

8. The method of claim 7, further comprising the step of:
(j) providing said purchase order to a vendor.

9. The method of claim 8, further comprising the steps of:
(k) updating said purchase order upon receipt from said vendor of any pricing updates; and
(l) updating said new sourcing data and said source list entry for said new item in the SAP material master database such that the pricing updates received from said vendor are available for subsequent requests and purchases.

10. The method of claim 8, wherein said updating steps are performed manually by the buyer.

11. The method of claim 8, wherein pricing updates received from the vendor are relayed via one or more of an electronic data interface (EDI) acknowledgement, a phone communication, or a facsimile communication.

12. An improved purchasing method for buyers using a high volume database and a high volume software program that is compatible with SAP® business management software (hereafter SAP program) having an SAP material master database, said method comprising the steps of:
(a) the high volume program receiving a request for the creation of a new record for a new item for future purchase, said request containing a plurality of data entries that are provided to the SAP program by the high volume program;
(b) from said data, the SAP program creating the new record and providing same to said high volume program;
(c) the high volume program examining the new record and determining that the item is a high volume item;
(d) the high volume program consulting the high volume database, which contains different types of items each respectively characterized by given sourcing data and a source list entry, and determining whether any of the items in said high volume database matches the new record;
(e) the high volume program determining that the new item does not match one of the items in the high volume database;
(f) providing notification that a new material has been created by the SAP program;
(g) creating new sourcing data for said new item and adding said new sourcing data to the SAP material master database; and
(h) using selected of the plurality of data entries from the request to manually create a source list entry for said new item and adding said source list entry to said SAP material master database.

13. The method of claim 12, wherein said plurality of data entries from said request comprise one or more of a description of the item, a commodity code associated with the item, an identifier of the manufacturer of the item, a manufacturer's product code for the item, an estimated price of the item, and a place where the item is to be shipped.

14. The method of claim 12, wherein said given sourcing data and said new sourcing data respectively comprise a purchasing info record configured to provide details about a vendor/purchaser relationship for said new item.

15. The method of claim 12, wherein said given sourcing data and said new sourcing data respectively comprise an outline agreement configured to provide details about a vendor/purchaser relationship for multiple items including said new item.

16. The method of claim 12, wherein said given sourcing data and said new sourcing data comprise information respectively characterized by at least one of pricing, administrative information, and text information.

17. The method of claim 12, wherein said step of the high volume program consulting the high volume database and determining whether any of the items in said database matches the new record comprises comparing identifiers for one or more of the new item, the manufacturer of the new item, and the facility requesting purchase of the new item.

18. The method of claim 12, further comprising the steps of:
(i) submitting a requisition for purchase of one or more of said new items; and
(j) the high volume program automatically creating a purchase order for the requested new items, said purchase order created from the record stored in said SAP material master database.

19. The method of claim 18, further comprising the step of:
(k) providing said purchase order to a vendor.

20. The method of claim 19, further comprising the steps of:
(l) updating said purchase order upon receipt from said vendor of any pricing updates; and
(m) updating said new sourcing data and said source list entry for said new item in the SAP material master database such that the pricing updates received from said vendor are available for subsequent requests and purchases.

21. The method of claim 20, wherein said updating steps are performed manually by the buyer.

22. The method of claim 20, wherein pricing updates received from the vendor are relayed via one or more of an electronic data interface (EDI) acknowledgement, a phone communication, or a facsimile communication.

23. An improved purchasing method compatible with SAP® business management software (hereafter SAP), comprising the steps of:
capturing a history of purchase orders;
using said history to compile a first record of total purchases of products from individual manufacturers;
using said history to compile a second record of total purchases from particular vendors; and
using the compiled information from said first record and said second record to negotiate from each said manufacturer and each said vendor a standard discount applicable to new items of said manufacturer to be purchased from said vendor.

24. A method as in claim 23, further comprising a step of:
compiling an item master database containing each said standard discount applicable to each said manufacturer and each said vendor.

25. A method as in claim 24, further comprising a step of:
using said item master database to order a never-before-purchased item from one of said manufacturers through one of said vendors.

26. A method as in claim 25, further comprising steps of:
automatically creating an information record for the never-before-purchased item, said information record including a commodity code, manufacturers' name, and delivery point information for the item;
using said information record to generate a purchase order for the item; and
transmitting to one of the manufacturer and the vendor, said purchase order.

27. A computer interface for an automated purchasing system, comprising:
a first template for providing information to request a new item, said first template configured to gather information including one or more of a description of the new item, a commodity code associated with the new item, the identity of the manufacturer, manufacturer's product code for this item, the estimated price of the item, and the location where the item is to be shipped;
a second template for entering a purchasing info record for said new item, said purchasing info record comprising information associated with pricing, administration information and text information governing a vendor/purchaser relationship for said new item; and
a third template for formulating a source list entry for said new item, said source list entry comprising information for all sourcing data across all vendors for said new item for a particular location.

28. The computer interface of claim 27, wherein said second template for entering the purchasing info record contains data entries for one or more of base price, applicable surcharges and discounts, freight, taxes, vendor part number, business contact for said new item, and vendor commodity code for said new item.

29. The computer interface of claim 27, wherein said source list entry comprises at least one purchasing info record and at least one outline agreement.

30. The computer interface of claim 27, wherein selected of said first, second and third templates are embodied in a graphical Web-based interface.

31. A computer-readable medium embodying one or more programs of instruction executable by a computer to perform method steps for purchasing a new item via an automated purchasing system, said one or more programs of instruction being compatible with SAP® business management software (hereafter SAP program) having an SAP material master database, said method comprising the steps of:
(a) receiving a request for the creation of a new record for a new item for future purchase, said request containing a plurality of data entries that are provided to the SAP program by the one or more programs of instruction;
(b) from said plurality of data entries, the SAP program creating the new record and providing same to said one or more programs of instruction;
(c) consulting a high volume database, which contains different types of items each respectively characterized by given sourcing data and a source list entry, and determining whether any of the items in said high volume database matches the new record;
(d) determining that the new item matches one of the items in the high volume database and selecting the matching item;
(e) using the estimated price from the request and the given sourcing data for said matching item to automatically create new sourcing data for said new item and adding said new sourcing data to the SAP material master database; and
(f) using selected of the plurality of data entries from the request and the source list entry for said matching item, the high volume program automatically creating a source list entry for said new item and adding said source list entry to said SAP material master database.

32. The computer-readable medium of claim 31, wherein said plurality of data entries from said request further comprise one or more of a description of the item, a commodity code associated with the item, an identifier of the manufacturer of the item, a manufacturer's product code for the item, an estimated price of the item, and a place where the item is to be shipped.

33. The computer-readable medium of claim 31, wherein said step of consulting a high volume database and determining whether any of the items in said database matches the new record comprises comparing identifiers for one or more of the new item, the manufacturer of the new item, and the facility requesting purchase of the new item.

34. The computer-readable medium of claim 31, wherein said given sourcing data and said new sourcing data respectively comprise a purchasing info record configured to provide details about a vendor/purchaser relationship for said new item.

35. The computer-readable medium of claim 31, wherein said given sourcing data and said new sourcing data respectively comprise an outline agreement configured to provide details about a vendor/purchaser relationship for multiple items including said new item.

36. The computer-readable medium of claim 31, said method further comprising the steps of:
(h) submitting a requisition for purchase of one or more of said new items; and
(i) the high volume program automatically creating a purchase order for the requested new items, said purchase order created from the record stored in said SAP material master database.

37. The computer-readable medium of claim 36, said method further comprising the step of:
(j) providing said purchase order to a vendor.

38. The computer-readable medium of claim 37, further comprising the steps of:
(k) updating said purchase order upon receipt from said vendor of any pricing updates; and
(l) updating said new sourcing data and said source list entry for said new item in the SAP material master database such that the pricing updates received from said vendor are available for subsequent requests and purchases.

39. The computer-readable medium of claim 38, wherein said updating steps are performed manually by the buyer.
